(19) United States
(12) Patent Application Publication
(10) Pub. No.: US 2002/0062280 A1
(43) Pub. Date: May 23, 2002

(54) System and method for transmitting goods, remuneration, and information

(76) Inventors: John Zachariassen, Toronto (CA); Rayan Zachariassen, Toronto (CA); Carrie Liddy, Toronto (CA); Margaret Hurley, Toronto (CA)

Correspondence Address: DEETH WILLIAMS WALL LLP, 150 YORK STREET, SUITE 400, TORONTO, M5H 3S5, CA

(21) Appl. No.: 09/988,933

(22) Filed: Nov. 21, 2001

Related U.S. Application Data
(60) Provisional application No. 60/252,360, filed on Nov. 21, 2000.

(51) Int. Cl. G06F 17/60

(52) U.S. Cl. 705/39

(57) ABSTRACT

The invention relates to a system and method for transmitting and receiving goods, remuneration (in cash or in kind), documents and related information between any two points, especially between different domains and/or distant locations. The invention remits and disburses over a communication network for multiple currencies or fungible goods using intermediaries. Designed to operate in mainstream, developed-world transaction environments, specific accommodation is made for security, communication, interfaces and physical reach appropriate for developing countries. The user interface may include features such as multiple language capabilities, graphics, audio and icons in order to optimize usability for a worldwide user base. Transaction flow between parties in the system may be one-to-one, one-to-many or many-to-one. Other unique features include the specific separation of the flow of information and the flow of the goods and/or funds; the creation of a de facto account or personal history; the ability to track transactions over time; the creation of information and cash networks; the employment of publicly accessible technology; a symmetrical design such that all end users have equal capabilities within the system; the capacity to accommodate both monetary and in-kind recompense in a transaction; an ability to accept a transaction without pre-registration of all parties to the transaction; the capacity for interactive negotiation of terms in commercial trade transactions; and a built-in community beneficiary contribution feature.

This application claims the benefit under 35 USC §119(e) of the following provisional application filed Nov. 21, 2000: U.S. Ser. No. 60/252,360 “System and Method for Transmitting Goods, Remuneration, and Information”.

### FIELD OF THE INVENTION

The invention relates to a system and method for transmitting and receiving goods, remuneration (in cash or in kind), documents and related information between any two points, especially between different domains and/or distant locations.

### BACKGROUND OF THE INVENTION

The present invention relates to a transmission and receipt system and method over a communication network for multiple goods and currencies using intermediaries. Backgrounds into the three primary anticipated end uses of the system (monetary remittance, commercial trade and document issuance) are given here.

Monetary Remittance Background

Globalization has resulted in movement of people across regions and nations on a scale unseen heretofore. Driven especially by economic purposes, people are becoming more mobile, temporarily or permanently migrating to areas offering better recompense for their labour and skills. Parallel to this phenomenon is the accelerating mobility of money, first on a corporate capital basis, and more increasingly reaching to the level of small enterprises and individuals. Wages earned by expatriate or migrant workers and sent to family members back home constitute important if not essential sources of income for many developing nations.

The accumulation of remitted funds in a location (say, a community, village or town), when properly administered, can result in a significant increase in the economic viability of that location by virtue of creating a capital base. This invention has the unique feature of explicitly creating a catalyst for fund creation in an identified location.

There currently exist methods for the transfer of funds between individuals across international borders and great distances. Existing methods and systems are consistently expensive to the systems'users, are unsatisfactorily slow and often unwieldy. Users or customers of current systems usually do not know, until after the full transaction has been completed (often after days or weeks are elapsed), the full set of charges and exchange rate penalties that the transaction is subject to. In other words, the remitters and recipients may know how much money has been sent, but will not know until the very last step of the transaction (the actual handover of funds) how much money will be received.

Aside from physical transport of cash or cheque, there are two main methods for remittance of funds: via bank transfer, or via non-bank financial institutions. In the case of the former, it is necessary that there be branches of the said bank (or one of its partner banks) in both the sender's and receiver's locations. There are few banks with global reach and none with global reach into all communities, whether urban or remote and rural locations. Bank transfers also require pre-existing relationships with the designated bank on the parts of both the sender and the recipient.

In the case of non-bank financial institutions, the relative cost of a small, single transfer such as is normally requested by a typical migrant worker is prohibitive. These institutions make a significant amount of their profit from optimizing their position in foreign exchange and therefore often do not (or cannot) offer an attractive exchange rate to customers.

Whether via bank or non-bank financial institution, there are significant additional costs to a remittance, ones inevitably incurred by users. These include the costs of transmitting any additional information associated with the transaction (especially notification of whether the remittance has taken place), the costs of travel to the financial institutions on both ends of the transaction and the opportunity costs associated with the time and travel spent on a transaction that could not be completed.

The default method of funds transfer has traditionally required a physical handover of cash at multiple points in the transaction. The advent of electronic communication systems has simplified the system to some extent. However, there remain problems. These include the fact that dedicated terminals and electronic networks are presently being used by banks within banking systems which permit electronic transfers inter se (as in U.S. Pat. Nos. 5,448,043 and 5,496,991). Remitting funds electronically to or from a location where there are no branches of a bank that participate in the banking system requires the services of intermediaries; the banking system alone is not sufficient.

Commercial Trade Background

Migration and globalization are also contributing to an increased capacity to trade goods and services on a truly global basis. In concept, the advent of wireless communication and the formation of continent-wide trading communities should result in virtually limitless trading opportunities. The reality thus far is that electronically-assisted trade is still limited to established trading communities in the developed world. Vast communities of producers, traders and purchasers are excluded from existing networks. The primary reason for this is the non-availability of a working system that incorporates local conditions (including infrastructure, language, weather, terrain, literacy, resources and production capacity) and enables access to this wider community of commercial trade.

Smaller producers—in both developed and developing countries—rely heavily on the services of middlemen in order to find a market for their goods. These producers do not have (and rely on middlemen for) access to relevant trading information, an ability to easily complete the payment portion of the transaction or an ability to deliver the goods. The middlemen facilitate trade, but can also be bottlenecks for producers and traders. The terms of commercial trade are controlled by these middlemen. For many smaller or remote producers, an ability to circumvent this control of the middleman will result in better terms and greater business.

There is thus a tremendous pent-up demand and latent need for a wide-reaching, easy-to-use, language-independent, multi-function trading system. This system will fill many requirements that will profoundly improve the commercial position of its users, at the lowest cost possible and with high reliability.

Document Distribution Background

Document issuance may be an offshoot of commercial trade, but in many instances is a function that stands alone. Health records, legal notices, election enumeration and license renewals are cases in point. They are necessary for the issuer and exist independent of a corresponding trade negotiation on the part of the document recipient. Many of the issues of reach and efficiency described under the backgrounds for monetary remittance and commercial trade apply here as well. An ability for document issuers of all types to have access to a system that ensures secure, authenticated delivery of the documents is sorely needed. Much of the assurance for many issuers is now done manually and is therefore prone to the drawbacks of such manual systems: time delays, reach, travel, distribution channels, human error and repudiation. A wide-reaching, flexible system of secure distribution of information in a determined format (a document) will have great demand. Governments and health care providers are obvious large-scale users of such a capability.

### SUMMARY OF THE INVENTION

The invention relates to a system and method for transmitting and receiving goods, remuneration (in cash or in kind), documents and related information between any two points, especially between different domains and/or distant locations. The invention remits and disburses over a communication network for multiple currencies using intermediaries. Designed to operate in mainstream, developed-world transaction environments, specific accommodation is made for security, communication, interfaces and physical reach appropriate for developing countries. The user interface may include features such as multiple language capabilities, graphics, audio and icons in order to optimize usability for a worldwide user base. Transaction flow between parties in the system may be one-to-one, one-to-many or many-to-one. Other unique features include the specific separation of the flow of information and the flow of the goods and/or funds; the creation of a de facto account or personal history; the ability to track transactions over time; the creation of information and cash networks; the employment of publicly accessible technology; a symmetrical design such that all end users have equal capabilities within the system; the capacity to accommodate both monetary and in-kind recompense in a transaction; an ability to accept a transaction without pre-registration of all parties to the transaction; the capacity for interactive negotiation of terms in commercial trade transactions; and a built-in community beneficiary contribution feature.

### BRIEF DESCRIPTION OF THE DRAWINGS

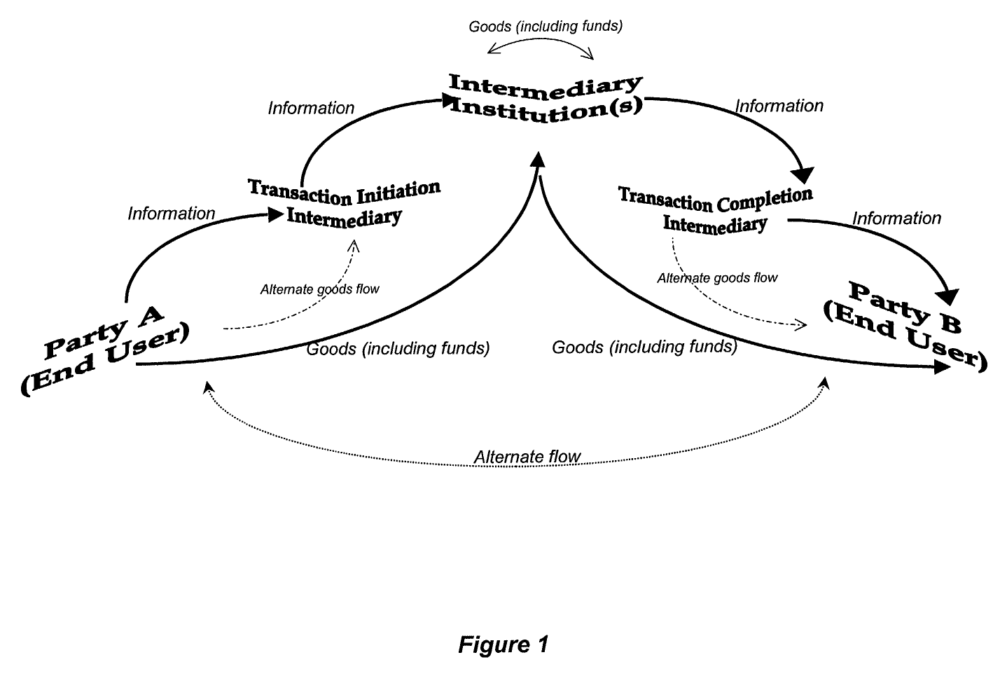

Embodiments of the invention will be described by way of example and with reference to the drawings in which: FIG. 1 depicts the flow of items and information.

### DETAILED DESCRIPTION OF THE PREFERRED EMBODIMENTS

General Overview

This invention discloses a system and method for transmitting and receiving funds, goods, documents or information via an electronic network, with unique security allowances, language-independent user interfaces and a device-independent technology architecture. In this document, these goods, documents, remuneration, information, etc. are denoted as “property”, even though a person transmitting the “property” may only be acting in the exercise of a right to control or dispose of the property on behalf of a person who has actual property interest, e.g. as an authorized agent or delegate for sending cash on behalf of the owner of the cash, or an employee acting for a company. Thus “property” as used in this document includes “possession”. The funds remitted may be denominated in multiple currencies; the goods traded may be of virtually any type; the documents and information transmitted may be in virtually any form. The communication network may be the public Internet; parts of the system may use a private network.

The invention maintains two separate aggregate flows of activity that are ultimately reconciled. The flow of funds, goods, information and/or documents (including physical cash handling, banking system transactions, messages, licenses, international clearing, carrier transport, import/export control and customs, for example) is one flow (realized by a first channel). The flow of information pertaining to transactions is the second. FIG. 1 shows an overview of the transaction model. Goods flow and information flow are depicted separately.

The primary users or customers are individuals, businesses or other organizations sending money, goods, documents and/or information to specified recipients in other, usually geographically separated, locations. These users will present funds (usually, but not necessarily, cash), information or an order for goods to an Intermediary with instructions to transmit those funds, information or order to a specified recipient(s). The transaction initiation process specifies the quantity, quality, type, brand, currency and other specific terms of the transaction. It is, in effect, the construction of the contract between the sender and the party effecting the transaction setting out the terms of the transaction. This formal initiation of the transaction is typically preceded by a series of negotiations among the relevant parties, facilitated by the system as described in this document, wherein possible terms are presented via the system and mutually agreed by the parties. In cases of monetary remittance, document issuance and information transmission, the negotiation step exists logically, but typically has minimal variation: the possible permutations of terms of the transaction are relatively limited (to such parameters as currency, contributions and format). The Intermediary accepts the funds, information or order and employs the system to generate any necessary instructions to all appropriate parties to the transaction, including a receipt or statement for the remitter or purchaser and instructions to Intermediaries responsible for the handling of funds, goods, documents and information. In the case of monetary remittance, the system's proprietors are typically acting as one of the Intermediaries and, as such, can ensure that funds and information flow through the system's mechanisms to result in the receipt of the funds and information, in the form and currency requested, by the specified recipient(s) within a relatively short time period.

In this document, the term “item”, when referred to as part of a transaction, refers to the physical manifestation of the transaction. This may be funds (in cash or other forms), it may be a message or other piece of information in its final form as delivered to the intended recipient (a document), or it may be physical goods. Transactions will also have associated information, separate from the items, that describe the transaction, the status of the transaction, the nature of the items and other relevant tracking, confirmation and security information.

Parties

The typical parties to a transaction are listed below. It may be easiest to depict these parties as individuals and organizations, but they need not necessarily be so. Some of the parties (Intermediaries, for example), may be virtual, with the system and its built-in logic automatically performing a role that may sometimes also be performed physically, by people or organizations.

End Users

Remitter

Transmitter

Purchaser

Recipient

Vendor

Issuer

Intermediaries

Transaction initiation intermediary

Transaction completion intermediary

Institutions

Receiving institution

Handling institution

Clearing institution

Delivery institution

Beneficiary Organizations

Community affiliation beneficiary

Optional beneficiary

The structure of the system is such that, logically, the flow of information and the roles of the parties are potentially symmetrical. The benefit of this structure is that it functions very well as a transmission or transaction processing capability, independent of the specific remittance, transfer, issuing or commercial trade function. This will allow expansion of the system to enhance activities under way in the targeted developing communities. Given the nature of the environments in which the system is to be implemented typically (low levels of access to technology, for example), the inventors have incorporated the knowledge that the system will be used in as many other capacities as end users can imagine, and a high reusability factor has been designed into the system.

Information relating to a transaction is accessible via communication media, including public networks (Internet). Cash and goods are controlled and transmitted via possibly both private and public networks, via partnerships and contractual arrangements. Both the information and cash networks typically flow both ways. This symmetry is explicitly part of the reusability design.

Roles of the Parties

In advance of any transaction, parties to the transaction identify themselves to the system. This identification and associated authentication (described more fully in the description of security features) trigger the lookup of a profile for the parties being authenticated. The profile identifies the category into which a particular party falls. Each of the parties to the system is typically allowed a specific set of privileges and requires a specific set of identifiers. These are described below for each of the major parties.

End Users

End Users (remitters, transmitters, purchasers, recipients, vendors and issuers) are typically identified to the system by means of biometric identification, the details of which are outlined in the description of the system's security features, below. Without the intervention of an Intermediary (physical or virtual), the End User is typically entitled to a limited set of privileges: general information access; account history; and feedback or e-mail, for example.

With the assistance of an Intermediary, an End User may initiate, inquire about or complete a transmission or remittance transaction. An End User has privileges of either sending or receiving information, funds or goods—but in one preferred embodiment, at a single point in time, for a single transaction, an End User will either be a transmitter or a receiver.

The initiation of a transmission or remittance transaction requires an End User to be acting in the role of remitter, transmitter or purchaser. In one preferred embodiment, the End User presents himself to the Intermediary (physical or virtual), together with the item(s) to be transmitted (cash, information, or an order for goods to be purchased, for example). As described in the security section, the End User needs only authenticate him or herself; there is no need for absolute, detailed identification. In other words, the End User may maintain anonymity, if desired. Anonymity is an option, not a requirement, of the system. The degree to which an End User provides detailed identity has no impact on the privileges to which the End User is entitled in the system. Legal and system limitations will have some bearing on the specifics of the privileges.

The system is designed with a great deal of flexibility around End User profile information. Anonymity is completely feasible, as is a fully detailed record of End User information. The benefits or drawbacks of detailed record-keeping about individuals is typically explained to the End Users at the outset and the level of information that the system keeps about them is at the discretion of the End User. Some End Users, for reasons of personal preference or privacy, may desire complete anonymity. Others may see benefit in keeping a full record of their identifying information so that they are easy to contact and may be more easily included in other off-shoot features of the system, including (but not limited to) the establishment of accounts, a feature described in the section on detailed transaction flow.

Having negotiated terms and/or presented item(s) for transmission and having been authenticated to the system, an End User then specifies the desired nature of the transaction to the Intermediary by means of selecting options available in the system. The main options available include one or more of monetary remittance, information management (including transmission) and commercial trade transactions. The initiating End User selects options such as recipient, quantity, terms and timeframe and typically verifies them with the Intermediary. This verification process is the end result of a negotiation, via the system, with all relevant parties. Upon joint verification of these options by the End User and the Intermediary, negotiation of the terms of the transaction is completed and the transaction is initiated (the contract to transmit is formed).

Inquiry about the status of transactions may be done by an authenticated End User either in the role of remitter/transmitter/purchaser/issuer or the role of recipient/vendor.

Completion of a transaction requires the authenticated End User to be acting in the role of recipient or purchaser. In one preferred embodiment, a transaction—be it information transmission, commercial trade transaction or monetary remittance—is not complete until the recipient or purchaser has verified the receipt of the described item(s). In the case of remittances, in the role of recipient, then, with the assistance of an Intermediary, an End User may review transaction details and may either accept or reject, formally to the system, that the transaction is as it should be. Upon acceptance, the End User and the Intermediary jointly verify to the system that the transaction has been completed to satisfaction, including record-keeping, printed receipts and the receipt of all specified items. Commercial trade applications may be taken to this extent, but terms of the transaction negotiated in the transaction initiation may define transaction termination as the successful shipment of the goods by a third party. This third party, then, would be responsible for tracking the final receipt of the goods by the purchaser. In the case of document transmission, confirmation of receipt via the system's authentication features would normally constitute transaction completion.

Intermediaries

Intermediaries may serve many of the authentication and crosscheck functions of the system. The following describes one preferred embodiment of the present invention. No transmission transaction may take place without the intervention of an Intermediary (physical or virtual). An Intermediary must be authenticated to the system discretely for each transaction. Every transaction carries with it an identifier of the Intermediary that facilitated the transaction. In the case of a virtual Intermediary, the identifier and the assurance of non-repudiation will take place through digital means and may not be obvious to the End User. Confirmation of major steps in a transaction must be done jointly by the End User and an Intermediary. An Intermediary has optionally additional privileges to enable the creation of a new End User profile (jointly with an authenticated End User) and changes to an existing End User profile (jointly with an authenticated End User). Intermediaries may also generate specific reports related to distribution and reconciliation of transaction items. Intermediaries may typically only make detailed inquiries into the details of transactions related to an individual End User in conjunction with that End User.

An Intermediary is usually required to have an understanding of the system's processes and, in addition to serving a verification and cross-check function, may also serve the function of providing assistance to the End User in proper use of the system.

A Transaction Initiation Intermediary works in conjunction with the End User (remitter, transmitter, purchaser or issuer) to define and verify a system transaction. This typically involves specification of the terms, conditions and parties to the transaction, with verification that the terms are acceptable to the system and the End User. There may be circumstances in which a proposed transaction is acceptable to the system, but requires explicit authorization (in the case, for example, of a transaction outside the legal boundaries as set by the legal system). For these non-standard circumstances, a higher level of privilege is required on the part of the authorizing Intermediary. Privilege is determined by policy and by law and is enforced through digital or physical means. There are, then, at least two types of Transaction Initiation Intermediary: one with standard authorization privileges and one with privileges to authorize transactions outside of set boundaries.

A Transaction Completion Intermediary works in conjunction with an End User that is acting as the recipient of goods, information, documents or remuneration as defined in the terms of the transaction. This Intermediary, together with the receiving End User, verifies that the terms of the transaction are described correctly and that the items delivered in the transaction are as described. The role of this Intermediary is essentially a mirror of the role of the Transaction Initiation Intermediary. It is typically only the joint confirmation by an End User and the Transaction Completion Intermediary that can conclude a transaction in the system. As with the Transaction Initiation Intermediary, this Intermediary may be virtual. In that case, digital means are used to enact this role, including digital signature and non-repudiation.

Institutions

The Institutions that act as parties to transactions in the system are almost exclusively involved in the physical flow of items in the transaction in a separate channel from that for flow of information. End Users are concerned equally with the information flow and the flow of funds or goods in a transaction. Intermediaries are primarily concerned with the information flow or tracking of a transaction. Institutions are primarily concerned with the flow of the items that constitute the transaction.

Institutions are usually in partnership with the proprietors of the system. They are not necessarily the proprietors of the system. The Institutions are entities that are already in business in roles similar or identical to the ones required by the system.

The Receiving Institution is the Institution that takes in the item(s) covered in a transaction. In the case of funds transmission, this Institution will accept from the Intermediary the funds submitted by the End User and hold them in an acceptable and reliable manner in preparation for transmission, possibly via other Institutions, to the intended recipient. In the case of goods, it may be a warehouse, for example. In the case of information or document transfer, it may be a file server, for example. An Institution may, but does not necessarily, have a contractual or business relationship with the Intermediaries. In any case, the Receiving Institution's status, responsibilities and contractual obligations are usually separate from those of the Intermediaries.

The Handling Institution receives the items from the Receiving Institution and is responsible for their safe and cost-effective transport to and from the Clearing Institution. The Clearing Institution is usually responsible for ensuring adherence to the policies and regulations around transport of specified items. In the case of funds transfer across borders, a Clearing Institution would usually be responsible for the bulk exchange of currencies at reasonable and recognized rates. In the case of international goods transfer, the Clearing Institution would usually be responsible for handling the import/export requirement between the specified locations. In cases of domestic goods transfer or certain information transfer, the Clearing Institution may not be a necessary and present party and would only exist conceptually.

Upon clearing, the items are typically once again in the hands of a Handling Institution, which is normally responsible for the transport of the items to the Delivery Institution. This Institution is normally responsible for ensuring that the items are safely acquired by the End User or Transaction Completion Intermediary. The Delivery Institution's responsibilities mirror those of the Receiving Institution.

There is no restriction on the organizational structure; merely that the functions must be fulfilled by whatever structure there is in place. What is presented here is a conceptual view of the organizational structure. None of the Institutions are predetermined. The system's logic allows for virtually limitless permutations of contractual arrangements among possible Intermediaries and Institutions.

It is possible, but not necessary, for the Receiving Institution, Handling Institution, Delivery Institution and even the Clearing Institution all to be the same Institution. It also possible that any one or more of these Institutions may not be a necessary party to a transaction and would therefore be a conceptual, logical or virtual, construct in the system—the party will have no physical manifestation. Existing remittance-only services have tended to de-couple the Clearing Institution portion from their model, but act as all other Institutions on their own behalf. The reach of these models is limited to locations where these Institutions have physical locations. By de-coupling these institutional roles, an embodiment of the present invention may employ a wide variety of Institutions to perform necessary functions in previously hard-to-reach locations. A trusted local Institution such as a school or community services organization may serve the function of a Receiving Institution, for example, in remote locations with no bank branches or remittance outlets. Established financial institutions may then, in turn, serve the function of Handling Institution.

The structure of parties within the system can be recursive: any interaction between two parties can logically be treated as End Users, using the same logical structures, one level removed form the normal case described herein.

Beneficiaries

A unique feature of this invention is an option for End Users in a transaction to have an associated community or other similar affiliation. Every transaction will have a portion of its value diverted such that it benefits the identified affiliations of the End Users. It is via this mechanism that the accumulation of assets in a community, as discussed in the background material, may be achieved. For each community with which an End User may be affiliated, a Community Affiliation Beneficiary may be established. This beneficiary is a vetted and accredited organization that will manage the accumulated value from the transactions and apply it to the socioeconomic development of the community that it represents. This diversion of a portion of the transaction value to a Community Affiliation Beneficiary is mandatory in one preferred embodiment.

There is provision in the system for parties to indicate additional beneficiaries at their discretion. Community affiliation is the base case, but the system acknowledges and expects that there will be myriad other types of beneficiaries that will be able to employ the system's feature of accumulation and diversion of value from transactions. These Optional Beneficiaries will also be accredited organizations recognized by the system.

Specific System Functions

Security

Security has been designed to optimize the level of control and minimizing the risk using the lowest-cost tools available. Security functions are based on tools including public key encryption.

Authentication

Authentication is the process of ensuring that parties to a transaction are indeed who they purport to be. Each physical party to the system (the process is different for virtual parties) is authenticated to the system using any combination of card- or database-stored identification. Biometric technologies may be supported through the use of public key infrastructure (PKI) based certificates. All security controls are transferable to mobile devices to ensure the portability of the application and its ease of use at remote locations. Virtual parties to the system are preferably authenticated via digital certificates, typically PKI-based, embedded in the system. Other methods of authentication include the use of one or more user credentials such as tokens, algorithms, and patterns, in addition to passwords and digital certificates as discussed.

Registration

Robust digital authentication of parties is dependent upon a reliable registration process. The initial registration of parties to the system is typically done through remotely located organizational partners, where the registrant to the system is known because of locally verifiable face-to-face contact or other generally reliable means. In areas where this is not possible, or in the event where face-to-face contact is not possible (such as where the party is a public institution or corporation), the authentication to the system will be verified through other means such as corporate registration databases.

Smart Cards

Smart cards will be the preferred vehicle for carrying and transmitting necessary identifying information (such as digital certificates and/or biometric verification data) for individual, physical parties. Smart cards, when available, will be used to help authenticate each party to the system. Each party is authenticated to the system through the use of the smart cards. The smart cards, when not available (either through theft or loss), will be replaced with a number of offsetting controls and policy measures which include the use of community-based re-registration authorities.

Biometric controls are being utilized to authenticate parties to the greatest extent possible. Biometric techniques are most useful for environments where theft and fraud are risks, where literacy levels are low, where names are not unique, where mobility is high and where physical conditions are variable.

Biometric Authentication

Biometric information connects the user profile to the account (described under details, below) and enables the fulfillment of the transaction. Biometric information also enables the parties to remain anonymous and unknown to any external entities, subject to laws and regulations in the jurisdictions in which it is used. Biometric information being utilized may include thumbprint, retinal scans, voice authentication and all other mechanisms being made possible. In cases where biometric information is not feasible or practical or desirable, more traditional authentication will be used. Verification of access and privacy of information will normally be maintained through the use (when available) of biometrically controlled access databases.

Access Control

Access control may be maintained through a combination of smart cards, biometrics and password control. Each tier of the application and system has its own access control measures, from physical access of End Users via biometric smart cards through to network security controls.

Non-Repudiation

Each transaction will usually be logged, and audit trails will provide the evidence necessary to ensure the integrity of each transaction. Historical file information will be logged and maintained to ensure the transactions are made available for each party, as appropriate according to privileges. Additionally, transactions may be hierarchically or relationally accumulated through the use of database technology to log and calculate the value of the total transactions for appropriate groupings (for example, the amounts to go to a Community Affiliation Beneficiary from a given day's transactions). This enables the primary and secondary verification of the integrity of the transaction itself.

Digital signature and time stamping may be used to produce records of non-repudiation necessary to validate the transaction as being authentic. Audit reports and tracking mechanism will allow for dispute processes to be entered into should there be any uncertainty in any transaction. Traditional, centrally-controlled and decentrally-distributed reporting ensures auditability and integrity of distribution.

Prior to the fulfillment of any transaction, parties must establish a recognized trust level with the system, and through that established trust authenticate themselves to the system. This is usually completed by presenting the credentials—normally in the form of smart card and biometric identification—and final verification of the authenticated parties to the fulfillment, including any End Users and Intermediaries. Prior to the transaction being completed, parties are authenticated a second time, providing both the time stamp and a two-party confirmation of the transaction being fulfilled.

Network Security

The confidentiality of each transaction is ensured through a number of different mechanisms. Network encryption and transmission messaging authentication are used to provide security for each message transmission. Each party, because of the issuing of a digital signature and certificate, is able to use confidentiality and encryption to further protect its information. Encryption and certification therefore enable the transmission protection mechanisms. Preferred embodiments of this invention use, but not necessarily exclusively so, open standard, publicly available or proprietary software and encryption technology.

Standards and Policy

As the scope of this application may be global in nature, the possible effects of local regulations and customs on operability—particularly on security policy—is recognized. Embodiments therefore would implement policy and standards that adhere to and recognize the relevant local legislation and regulations as dictated through corporate and government policy and regulations. Such policies are identified and application controls implemented to address these items. For example, in the prevention of money laundering, many jurisdictions mandate reporting of transactions over certain absolute or cumulative values. Embodiments of this invention would optionally create reports to identify these transactions and arrange to forward the information to the appropriate bodies.

Prevention of Fraud

This invention involves business processes that provide for the development of custom standards and policy for each region to prevent the use of the system in criminal activities. Limits on the daily and cumulative transfer amounts for each party are one example. The system tracks transactions and prevents the completion of any that are over the minimum set by business policy and relevant government authorities.

Transaction Flow

Information Flow

Transactions require End Users. All End Users must have a profile in the system before being able to initiate a transaction. An End User profile is typically created via an Intermediary. After authentication (see description in security section, above), an End User may have a profile created. An End User's authentication is separate from an End User's profile in this system. The authentication is the result of an external security process with which this system is compatible and upon which it builds. Authentication verifies the veracity and uniqueness of an individual. It does not necessarily describe anything more about them—particularly not information related to transactions. The user profile does that.

End User Profile

The user profile is a set of attributes related to an End User. The profile has the capacity to collect and retain a variety of data points and relate them to an individual, possibly including such things as the individual's name, occupation, address, preferred activity profile and so on. Where appropriate, End Users will be encouraged to provide sufficient information in their profiles to enable maximum service delivery capability on the part of the proprietors of this system and their partner Institutions and Intermediaries. The only data that a system embodiment of this invention normally requires about a user are the following:

the authentication described in the security section

an identifier, typically self-selected, that is easy for the End User to recognize and remember

an affiliation for purposes of processing beneficiary contributions

A transaction is initiated upon the presentation of an authenticated End User to an authenticated Intermediary (virtual or physical) with a specific request for the transmission of funds, information or other item to a specified recipient. Both parties identify themselves to the system and inform the system of the intended transaction. The details of the transaction are entered into the system. These details may be reviewed by the End User and modified until they are satisfactory. Upon satisfactory entry of the details of the transaction, the End User typically makes a formal confirmation to the system and the transaction is then accepted.

Each transaction typically has a minimum of three discrete steps: a confirmed transaction initiation, which requires the involvement of an End User and a Transaction Initiation Intermediary; transaction handling, which requires any combination of Institutions; and a confirmed transaction completion, which requires the involvement of an End User and a Transaction Completion Intermediary. Though not strictly necessary, many transactions (especially commercial trade) will also entail a set of negotiations prior to the formal transaction initiation. It is entirely possible that one party will have the authority or capacity to act as both a Transaction Initiation Intermediary and a Transaction Completion Intermediary, for example. That party cannot, however, do so without interruption—the three major steps are discrete actions in the system. The Intermediary must authenticate in the appropriate role.

Negotiation

The negotiation process most typical to the commercial trade function has specific bearing on the user profile (discussed above) and on the user interface (discussed below). End Users will be presented with a set of parameters relevant to the transaction(s) in which they wish to engage. These may include such factors as type of goods, quantity, quality, preferred delivery channel, discounts, payment method, insurance, fees and export restrictions. End Users will, based usually on their user profiles, be presented with this set of parameters in a form (e.g., text, voice, language preference) that is most useful to them. The possible forms of presentation include ones that accommodate a range of appropriate media that are suitable to the ethnic, cultural, regional, educational and other particular attributes of the parties. From this set of parameters, known to the system, users will make choices, transmit them back and forth as tentative offers and finally settle between them on a satisfactory arrangement, formally initiating the transaction. These parameters are usually stored in the user profile and are offered as possible default values to the End User when next a similar transaction type is attempted.

End User Accounts

By virtue of the fact that End Users have identities within the system (by virtue of the authentication and the user profile), it is possible to retain a history of all transactions specific to any authenticated End User. This capability enables the establishing and maintaining of a history of transactions for each authenticated End User: a de facto “account”. This capability has several advantages. Given that many of the Institutions and End Users of the system will be using this system for as many possible follow-on functions as possible, the first advantage is that this capability becomes the linking point to any number of other applications that could take advantage of an account. This is particularly important in locations where most people do not have accounts of any type established anywhere. For the first such account to be established at the point where the most significant assets of the community are accumulated (i.e., the monetary remittance function or commercial trading) makes its potential usefulness even greater. Another advantage of an account-type capability is that it enables the viewing and analysis of patterns and histories of transactions for individuals and groups, enabling better service delivery.

The attributes associated with a user profile may be independently structured. A set of logically-related attributes within a user profile may be hierarchically structured, while another set of attributes may be simply mapped to other relevant attributes in order to allow the system to perform its defined functions. Attributes may be structured in independent hierarchies or databases. These hierarchies or databases are associated to such a point that appropriate interaction between the system and the user is ensured. For example, default transaction profiles, preferred language and account history attributes could combine to present a party with a transaction template in the appropriate language and format.

User Interfaces

Because of the potentially global nature of actual embodiments of the invention, the user interface is designed to accommodate multiple languages and non-textual interface options including (but not limited to) images, icons and voice. The user profile (described above) contains the relevant information (such as preferred language) that will enable the appropriate version of the user interface to present itself to an authenticated user automatically.

In addition to the variety of languages required for users in a global system, there is a requirement to enable ease of use for parties to a transaction that may have limited literacy. This is managed through the use of images, icons, voice and marks to depict actions. Further, features may be built in such that non-traditional users of electronic systems will receive frequent assurances that transactions are being executed properly. An example of this is a feature that utilizes information about the End User from the user profile and automatically presents familiar images: for example, in one preferred embodiment, upon authentication to the system and a reference to the associated user profile, an End User will be presented with an interface that explicitly demonstrates its recognition of that End User via a depiction of a familiar landmark from the End User's home community.

The user interface is designed to simplify interactions as much as possible. To that end, default transaction streams are developed wherever feasible (see description under negotiation, above). In one preferred embodiment, the distribution chain is determined in a first-time transaction via a combination of factors related to the transaction and the user profile. That chain is then stored and is presented as the default chain on the next use.

Transaction

In order to get to the point where an initiated transaction may be confirmed, certain data must be entered and verified. In the case of funds transfer, the End User will typically specify:

a recipient

an amount (the value of the transaction)

the currency in which the transaction is to be completed

Certain other information is required but normally already known to the system:

profile or identifier of the End User (remitter/transmitter)

the currency in which the transaction is initiated

the beneficiary of the system's built-in affiliation contribution

Still other information may be given, but is not required for a transaction

additional beneficiaries for optional additional beneficiary contributions

value of additional beneficiary contributions

There may be cases in which the information required to properly identify the desired recipient is not known to the remitter/transmitter. In one preferred embodiment, the system has a facility to search for the desired recipient by way of the recipient user profiles. These profiles are designed in such a way as to accommodate the myriad ways in which people in a variety of communities might most easily identify themselves—nicknames, occupation, household information, family affiliation, family relationship and many others. The intent is to enable record searches for people for whom western-style naming standards are not familiar.

Once sufficient information has been jointly specified and confirmed by the End User and the Transaction Initiation Intermediary, the transaction initiation is complete. Upon confirmation of the initiated transaction, the system typically accumulates and reports information related to the transaction to the relevant parties. The End User on the initiating end typically receives a confirmation of all details. The system accumulates information by Receiving Institution, Handling Institution, Clearing Institution, Delivery Institution, Beneficiary Organization, Transaction Initiation Intermediary and End User.

Reports are usually generated and distributed to the appropriate parties on a predetermined timescale.

Activities related to the physical flow of the transaction typically take place at this point, based on the information transmitted to the various Institutions. These activities are discussed below under the discussion of the physical flow of items.

In one preferred embodiment, on a regular basis, Delivery Institutions will receive notices (via reports or messages) of the pending transactions for which they will be responsible. Because these Institutions are not necessarily associated with the other Institutions in the process, it is important for Delivery Institutions to receive this notice, since transaction completion may require the physical acquisition of items on their part (cash, goods or documents). Once the system informs the Delivery Institution of its obligations, the relevant End Users are also informed, including via the system directly or via the Delivery Institution (depending upon physical conditions).

Once informed of a pending transaction, the End User (recipient) authenticates himself to the system in conjunction with a Transaction Completion Intermediary. In a process that closely mirrors the initiation process, the End User reviews the information related to the transaction. The End User typically has a choice regarding the final disposition of the items being transmitted. The items may be collected at that time, or they may be held, wholly or partially, with a record of this maintained by the system. The End User may choose to have a portion of the transaction realized in a handover of cash or goods and a portion realized in a transfer to a known account in this or another application to which an appropriate interface has been built. This capability is a crucial one—it will enhance the ability of both individuals and communities to much better manage accumulated assets.

Having chosen the desired disposition of the transaction, the End User, jointly with the Transaction Completion Intermediary, formally confirms to the system the realization of this transaction. Once the transaction is confirmed, an audit trail is established, containing verification of the transaction (including, in the case of monetary remittance, the confirmation of the actual payout) and non-repudiation. Upon this formal confirmation, the transaction is deemed to be completed, and a confirmation with the transaction details is issued to the End User.

Distribution Channels

There are two sets of choices for determining the distribution channel employed in a transaction. The first is for funds or for documents, where the system makes part of the determination of the Intermediary Institutions to be used (by virtue of being a default Intermediary). This choice is partly driven by the user profile because of its association with location and community affiliation. The associated approach and databases are typically hierarchical in organization. The second is for goods, where the distribution channel is determined via negotiations between the purchaser and the vendor. Its associated approach and databases are typically relational in organization and are typically determined by the user.

Physical Flow of Items

Initiation of a transaction may take place via any Receiving Institution and completion via any Distributing Institution. In the case of funds transfer in particular, this is an important and differentiating capability. The established electronic networks of financial institutions generally have an ability to disburse funds to users outside of their proprietary circle, but they cannot accept funds for those same users. This system has similarities in this respect to payment systems. In the case of fungible goods, much of the same is true. For more specific or value-added goods, there will be greater limitations to the possible Distributing Institutions at which transaction completion will be possible.

The Transaction Initiation Intermediary formally transfers both the physical items and a description of the items (via the system data) to the relevant Receiving Institution. The Receiving Institution is then responsible for both tracking and transferring the items to a Handling Institution. The Handling Institution performs any physical or electronic delivery necessary to get the items to a Clearing Institution, as necessary. The Clearing Institution may have multiple entities with which to interact in order to enable the physical transfer of items across borders. Typically the Clearing Institution has responsibility for ensuring that the requirements of those entities (such as governments, banks, insurance, etc.) are known and met. Once the Clearing Institution has enabled the transfer of items across borders, a Handling Institution ensures that the items are delivered to the appropriate Distributing Institution.

At each point of interaction between Institutions, a reconciliation may be possible. The relationships of specific Institutions to each other will generally dictate whether a reconciliation is actually done at any particular point. Formal reconcilations are done by the system at the major points of delivery. Informal or ad hoc reconciliation and inquiry may be be done at any point via system reports and queries.

It is possible that Distributing Institutions may be confronted with requests to honour a transaction, the items for which have not yet arrived at the specific Distributing Institution location. Information flow will be virtually instantaneous, while physical flow of items will take some time. Even electronic funds flow, by virtue of the clearing requirements, may take days. One method for dealing with this common situation is the establishment of a “float” or “warehouse” of items from which Distributing Institutions may draw in order to honour and complete the known transactions in a timely manner. The system takes and manages the risks associated with this approach, recognizing its necessity in achieving the capability to complete transactions as fast as possible.

If delivery of the property could not be effected by the distribution channel, the communication channel would typically attempt to notify the end users and obtain instructions from the transmitter/remitter or an institutional member of the distribution channel. The instructions may be to redirect the delivery to a third party at a specified address, cancel the delivery and return the property to the originating user, or deliver to the receiving user at another address.

It will be appreciated that the above description relates to the preferred embodiments by way of example only. Many variations on the apparatus for delivering the invention will be obvious to those knowledgeable in the field, and such obvious variations are within the scope of the invention as described and claimed, whether or not expressly described.

All patents, patent applications, and publications referred to in this paper are incorporated by reference in their entirety.

We claim:

1. A method for assisting a transaction for delivering a property of a first end user to a second end user with the ministrations of a first and a second intermediary, having a communication channel to effect information flow comprising electronic processors and input-output devices, a database having a profile for the first end user, and a communication network, comprising the steps of:
A first electronic device of the communication channel receiving from the first end user instructions to deliver the property to the second end user
The first electronic device presenting the terms of delivery to the first end user;
The first electronic device receiving a confirmation of acceptance of the presented terms from the first end user;
A distribution channel receiving the property; and
the distribution channel delivering the property.

2. The method of claim 1, wherein the step of the distribution channel receiving the property comprises the subsequent step of the communication channel conveying a notification to the second end user of a pending delivery of the property.

3. The method of claim 1, wherein the step of the distribution channel delivering the property to the second end user comprises the subsequent step of a second electronic device of the communication channel receiving from the second end user a verification of completion of the transaction.

4. The method of claim 1, where the step of the first electronic device of the communication channel receiving instructions to deliver the property comprises the prior step of the first end user and the second end user engaging in negotiations.

5. The method of claim 1, where the terms of delivery comprising the charges for delivery, any applicable foreign currency exchange rate and taxes.

6. The method of claim 1, wherein the step of the distribution channel receiving the property comprises the distribution channel receiving the property directly from a party other than the first end user.

7. The method of claim 1, wherein the step of the distribution channel delivering the property to the second end user comprises the distribution channel making available the property to the second end user.

8. The method of claim 1, wherein the step of an electronic device receiving from the first end user instructions to deliver the property to the second end user comprises the step of first authenticating jointly the first end user and the first intermediary.

9. The method of claim 8, wherein authenticating an end user comprises receiving from the end user a user credential being an identifier and password, if the end user is a human person.

10. The method of claim 8, wherein the step of authenticating jointly the first end user and the first intermediary comprises an authenticating device receiving a biometric sample from the first end user if the first end user is a human person, and the authenticating device is adapted to employ a biometric technique for authentication.

11. The method of claim 8, wherein the step of authenticating jointly the first end user and the first intermediary comprises the step of an authenticating device receiving a biometric sample from the first intermediary if the first intermediary is a human person, and the authenticating device is adapted to employ a biometric technique for authentication.

12. The method of claim 10, wherein the biometric technique comprises at least one of the modalities identified as fingerprint, hand scan, iris scan, retinal scans, face recognition and voice recognition.

13. The method of claim 8, wherein the step of authenticating jointly the first end user and the first intermediary comprises the step of the authenticating end user presenting a smart card to an authenticating device, and the authenticating device is adapted to receive a smart card for authentication.

14. The method of claim 8, wherein the step of authenticating jointly the first end user and the first intermediary comprises the step of the authenticating intermediary presenting a smart card to an authenticating device, and the authenticating device is adapted to receive a smart card for authentication.

15. The method of claim 8, wherein an intermediary is virtual and authentication of the intermediary takes place completely by electronic means.

16. The method of claim 8, wherein authentication uses at least one user credential selected from the group comprising a PKI-based certificate, a token, an algorithm, and a pattern.

17. The method of claim 3, wherein the step of an electronic device receiving from the second end user a verification of completion of the transaction comprises the step of first authenticating jointly the second user and the second intermediary.

18. The method of claim 1, wherein the communication channel is adapted to create a temporary profile for the second end user if the database has no profile for the second end user.

19. The method of claim 1, wherein the second end user has a profile identical to the profile of the first end user.

20. The method of claim 19, wherein the profile for an end user, other than a temporary profile, contains information:
for authenticating the end user;
for a self-selected identifier; and
on an affiliation whereby contribution to beneficiaries may be facilitated.

21. The method of claim 20, wherein the terms of delivery comprises the condition that the first end user makes a monetary contribution to at least one beneficiary.

22. The method of claim 21, wherein one beneficiary is associated with the affiliation.

23. The method of claim 20, wherein the step of the first electronic device receiving confirmation of acceptance of the presented terms from the first end user comprises the step of receiving from the first user an election concerning at least one institution member of the distribution channel, whether the at least one institution member is to be determined by the first end user or by reference to the information in the profiles of the first and the second end user.

24. The method of claim 20, wherein the at least one institution member of the distribution channel are determined by reference to the information in the profiles of the first and the second end user.

25. The method of claim 1, wherein the institution members of the distribution channel are determined by the first end user.

26. The method of claim 1, wherein the distribution channel is adapted to effect delivery of the property without knowledge of the personal identity of at least one of the end users.

27. The method of claim 1, further comprising the step of The communication channel notifying the end users, and receiving instructions from the first end user or an institutional member of the distribution channel, if delivery of the property could not be effected by the distribution channel.

28. The method of claim 27, wherein the instructions is one chosen from the group consisting of redirecting the delivery to a specified third end user, canceling the delivery and returning the property to the first end user, and delivery to the second end user at another address.

29. The method of claim 1, wherein the electronic device communicating with a communicating end user, the communicating end user being one from the group consisting of the first end user and the second end user, effects presentation to and reception of multimedia information from the communicating end user using language, icons and graphical images adapted to be meaningful to the communicating end user, having regard to at least one of the regional, cultural, educational, and ethnic nature of the communicating end user as recorded in the communicating end user's affiliated profile.

30. The method of claim 31, wherein the electronic device receives a selection of the multimedia language, icons and graphical images from the communicating end user.

31. The method of claim 30, wherein the selection of the multimedia language, icons and graphical images results from information kept in the communicating end user's affiliated profile as to the geographical location of the communicating end user.

32. The method of claim 1, wherein a history of transactions and the default transaction attributes are recorded in the database concerning a record end user, the record end user being one from the group consisting of the first end user and the second end user.

33. A method of assisting the formation and performance of a trade agreement for transferring a first property between a first end user to a second end user and a second property from the second end user to the first end user, with the ministrations of a first and a second intermediary, having a communicating channel to effect information flow comprising electronic processors and input-output devices, a database, and a communication network, the database recording for each end user a profile, and having a distribution channel for distribution of property, comprising the steps of:
The first and second end user negotiating the terms of the agreement of trade;
If the first and second party come to agreement over the terms of the proposed agreement:
A first electronic device of the communication channel receiving from the first end user instructions to deliver the first property to the second end user;
A second electronic device of the communication channel receiving from the second end user instructions to deliver the second property to the second end user;
The distribution channel receiving and effecting the delivery of the first property;
The distribution channel receiving and effecting the delivery of the second property;
The communication channel conveying a notification to the first end user of pending delivery of the second property;
The communication channel conveying a notification to the second end user of pending delivery of the first property;
A third electronic device of the communication channel receiving from the first end user a verification of receipt of the second property; and
A fourth electronic device of the communication channel receiving from the second end user a verification of receipt of the first property.

34. The method of claim 33, wherein the step of the first and second end user negotiating the terms of the agreement comprises using an external module to effect negotiations.

35. The method of claim 1, wherein property comprises funds, and the distribution channel comprises at least one institution member.

36. The method of claim 35, wherein none of the institution members constituting the distribution channel is a financial institution.

37. The method of claim 35, wherein funds is selected from the group consisting of cash, certificates for cash, a promise to pay, an entitlement to cash, and letters of credit.

38. The method of claim 35, wherein the funds delivered by one end user is denominated in a currency different than that received by the other end user.

39. The method of claim 35, wherein the distribution channel provides a float fund, whereby advances may be made to the second end user using a delivery institution member of the distribution channel.

40. The method of claim 35, wherein the step of the distribution channel delivering the property comprises the second user receiving the entirety of the funds.

41. The method of claim 35, wherein the step of the distribution channel delivering the property comprises the second end user receiving a partial amount of the funds.

42. The method of claim 35, wherein the step of the distribution channel delivering the property to the second end user comprises the second end user directing that all or a partial amount of the funds be transferred to an account.

43. The method of 33, wherein a distributed property, being one from the group consisting of the first property and the second property, comprises funds, and the distribution channel comprises at least one institution member.

44. The method of claim 1, wherein property comprises goods of a specific nature, and the distribution channel comprises at least one institution member.

45. The method of claim 33, wherein the distributed property, being one selected from the group consisting the first property and the second property, comprises goods of a specific nature, and the distribution channel comprises at least one institution member for delivery of the distributed property, whereby the distribution end user is the second end user if the distributed property is the first property and the distribution end user is the first end user if the distributed property is the second property.

46. The method of claim 44, wherein the distribution channel provides a contingent supply of goods, advances may be made of the property to the second end user.

47. The method of claim 1, wherein property comprises:
The subject matter of intellectual property; and
Entitlement to services.

48. The method of claim 47, wherein the subject matter of intellectual property is chosen from the group consisting of copyright, patent, trade secret and know-how, semiconductor chip design, and trademark.

49. The method of claim 1, wherein property comprises a document issued by the first end user.

50. The method of claim 49, wherein the document is one from the group consisting of a health record, insurance records, claim forms, database records, a legal notice, an election enumeration, and a license.

51. The method of claim 1, wherein property comprises information, and the distribution channel constitutes part of the communication channel.

52. A system for assisting a transaction for delivering a property of a first user to a second end user with the ministrations of a first and a second intermediary, comprising a communication channel and a distribution channel, the communication channel effecting information flow comprising electronic processors and multiple electronic input-output devices, a database having a profile for the first end user, and a communication network, wherein
A first electronic device of the communication channel:
receives from the first end user instructions to deliver the property to the second end user;
presents the terms of delivery to the first end user;
receives a confirmation of acceptance of the presented terms from the first end user;
The distribution channel:
receives the property; and
delivers the property.

53. A system for assisting a transaction for delivering a property of a first user to a second end user with the ministrations of a first and a second intermediary, comprising a communication channel effecting information flow and a distribution channel, the communication channel comprising electronic processors and multiple electronic input-output devices which are adapted to communicate multimedia information using language, icons and graphical images adapted to be meaningful to the human end user, having regard to the regional, cultural, educational, and ethnic nature of the human user, a database having a profile for the first end user, and a communication network; wherein
A first electronic device of the communication channel receives from the first end user instructions to deliver the property to the second end user, and authenticates jointly the first end user and the first intermediary;
The first electronic device presents the terms of delivery to the first end user, the terms comprising the charges for delivery, any applicable foreign currency exchange rate and taxes;
The first electronic device receives confirmation of acceptance of the presented terms from the first end user;
the distribution channel receives the property and delivers the property;
The communication channel conveys a notification to the second end user of a pending delivery;
A second electronic device of the communication channel receives from the second end user a verification of completion of the transaction after authenticating jointly the second end user and the second intermediary.
